(19) United States
(12) Patent Application Publication
(10) Pub. No.: US 2011/0242700 A1
(43) Pub. Date: Oct. 6, 2011

(54) METHOD OF PRODUCING MAGNETIC STORAGE MEDIUM, MAGNETIC STORAGE MEDIUM AND INFORMATION STORAGE DEVICE

(75) Inventors: Kenji Sato, Kawasaki (JP); Tsutomu Tanaka, Kawasaki (JP); Takuya Uzumaki, Kawasaki (JP); Tsutomu Nishihashi, Susono (JP); Tadashi Morita, Tsukuba (JP); Kazuhiro Watanabe, Susono (JP)

(73) Assignee: ULVAC, INC., Chigasaki-shi, Kanagawa (JP)

(21) Appl. No.: 13/131,803

(22) PCT Filed: Dec. 22, 2009
(86) PCT No.: PCT/JP2009/071324

§ 371 Date: May 27, 2011

(30) Foreign Application Priority Data
Dec. 26, 2008 (JP) 2008-332333

(51) Int. Cl. G11B 5/64; G11B 21/02; G21K 5/00

(52) U.S. Cl. 360/75; 428/826; 250/492.3; G9B/21.003

(57) ABSTRACT

The following abstract replace prior abstract in the application. It is an object to provide a simple and practical method capable of producing a magnetic storage medium of a type such as a bit-patterned type, a magnetic storage medium of the above-mentioned type and an information storage device which may be produced by such a simple and practical method, and in a method of producing a magnetic disk, there are performed: a film-forming process of forming, on a glass substrate 61, a magnetic film 62 so that the Curie temperature becomes 600 K or lower; and an ion injection process (C) of injecting ions locally into an area other than a predetermined protected area on the magnetic film 62.

### TECHNICAL FIELD

The present case relates to a method of producing a magnetic storage medium, the magnetic storage medium, and an information storage device including the magnetic storage medium.

### BACKGROUND ART

Hard Disk Drives (HDD) have been in the mainstream of information storage device, as a mass-storage device capable of high-speed access and high-speed transfer of data. As to this HDD, the areal recording density has increased at a high annual rate so far, and a further improvement of the recording density is still desired even at present.

In order to improve the recording density of the HDD, it is necessary to reduce the track width or shorten the recording bit length, but when the track width is reduced, the so-called magnetic interference easily occurs between adjacent tracks. This interference is, namely, a generic name for a phenomenon in which a track next to a target track is overwritten with magnetic recording information at the time of recording, and a phenomenon in which crosstalk occurs due to a leakage magnetic field from a track next to a target track at the time of reproduction. Either of these phenomena becomes a factor that results in a drop in S/N ratio of regenerative signal, causing deterioration in error rate.

On the other hand, when the recording bit length is shortened, there occurs a thermal fluctuation phenomenon in which performance of storing the recording bit for a long time decreases due to an influence of the magnetic interference.

As a magnetic storage medium avoiding these magnetic interference and thermal fluctuation phenomenon and thereby realizing a short bit length or a high track density, a magnetic storage medium of a discrete track type has been proposed. Further, other than the magnetic storage medium of the discrete track type, a magnetic storage medium of a bit-patterned type has been also proposed (for example, see PTL 1). In particular, in the magnetic storage medium of the bit-patterned type, the position of a recording bit is predetermined, a dot (magnetic dot) made of a magnetic material is formed in the predetermined position of the recording bit, and a part between the dots is made of a non-magnetic material. When the dots made of the magnetic material are thus separated from each other, the magnetic interaction between the dots is small, and the above-described interference and thermal fluctuation phenomenon are avoided.

Here, conventionally, many of the magnetic storage media of the bit-patterned type are produced by the following production method. In this production method, first, a uniform magnetic film is formed on a substrate. Subsequently, from the magnetic film, an area other than an area used as bits is removed by a technique such as etching or the like, so that magnetic dots are formed. And then, the area after the removal is filled with a non-magnetic material, so that a between-dot separating band that magnetically separates the magnetic dots is formed. By such a sequence of processes, a magnetic storage medium of the bit-patterned type is obtained.

Here, in such a conventional production method, there easily occurs a difference in thickness between the magnetic dot and the between-dot separating band. Therefore, in such a conventional production method, in order to stabilize the floating property of a magnetic head above the magnetic storage medium, flattening with high accuracy is necessary for the surface of the magnetic storage medium. Accordingly, there arise such a problem that a very complicated manufacturing process needs to be performed and such a problem that the production cost increases.

Thus, there is proposed a processing method (ion doping system) of forming a separation state of magnetic dots by injecting ions into a magnetic film and thereby changing a magnetized state locally (for example, see PTL 2 through PTL 4).

According to this ion doping system, the magnetic property is changed by injecting the ions and thus, complicated manufacturing processes such as etching, filling and flattening are unnecessary, making it possible to suppress an increase in production cost to a large extent.

Citation List

Patent Literature

PTL 1: Japanese Patent No. 1888363, specification

PTL 2: Japanese Patent No. 4006400, specification

PTL 3: Japanese Laid-open Patent Publication No. 2002-288813

PTL 4: Japanese Laid-open Patent Publication No. 2003-536199

### SUMMARY OF INVENTION

### Technical Problem

However, mere application of the ion doping system reduces only magnetic anisotropy, and hardly changes saturation magnetization and thus does not solve the interference due to magnetic interaction and thermal fluctuation described above and therefore, practical use is not attained.

Incidentally, up to this point, by taking the magnetic storage of the bit-patterned type as an example, there has been described such a problem that practical use of the above-described simple production method has not been achieved. However, such a problem is not limited to the magnetic storage medium of the bit-patterned type, and also applies to, for example, the magnetic storage medium of the discrete track type. In other words, such a problem commonly applies to magnetic storage media each having a magnetic section in which information is magnetically recorded, and a low magnetic section having saturation magnetization smaller than the saturation magnetization of the magnetic section.

In view of the foregoing circumstances, it is an object of the present application to provide a simple and practical production method capable of producing the magnetic storage medium of the type described above, the magnetic storage medium of the type described above and an information storage device produced by such a simple and practical method.

### Technical Solution

A basic form of a method of producing a magnetic storage medium achieving the above object includes magnetic-film-forming and ion-injection.

The magnetic-film-forming includes forming a magnetic film such that a Curie temperature is 600 K or lower.

The ion-injection step includes locally injecting an ion into an area other than a predetermined protected area, for the magnetic film.

Further, a basic form of a magnetic storage medium achieving the above object includes a substrate, a magnetic section and a low magnetic section.

The magnetic section has a magnetic film formed such that a Curie temperature is 600 K or lower, and information is magnetically recorded thereon.

The low magnetic section has an injected film in which an ion is injected into a magnetic film continuing to the magnetic film of the magnetic section, and has saturation magnetization smaller than saturation magnetization of the magnetic section.

Furthermore, a basic form of an information storage device achieving the above object has the above-described magnetic storage medium, a magnetic head and a head-position control system.

The magnetic head approaches or contacts the magnetic storage medium, thereby magnetically recording and/or reproducing information on and/or from the magnetic section.

The head-position control system moves the magnetic head relatively to a surface of the magnetic storage medium, thereby positioning the magnetic head over the magnetic section on and/or from which the information is to be written and/or reproduced by the magnetic head.

### Advantageous Effects

According to the present case, it is possible to provide a simple and practical method capable of producing a magnetic storage medium of a type such as bit-patterned type, a magnetic storage medium of the above-described type and an information storage device produced by such a simple and practical method.

### BRIEF DESCRIPTION OF DRAWINGS

FIG. 1 is a diagram that illustrates an internal structure of a Hard Disk Device (HDD) that is an exemplary embodiment of the information storage device.

FIG. 2 is a perspective view that schematically illustrates the structure of the magnetic disk illustrated in FIG. 1.

FIG. 3 is a diagram that illustrates the production method of the type producing the magnetic storage medium of the bit-patterned type, by etching and filling with the nonmagnetic material.

FIG. 4 is a diagram that illustrates the method of producing the magnetic disk illustrated in FIG. 1 and FIG. 2, by using the ion doping system.

FIG. 5 is a graph that illustrates a calculative correspondence between a saturation magnetization vanishing degree due to the ion injection and the Curie temperature after ion injection, in the magnetic film with the Curie temperature of 500 K before the ion injection.

FIG. 6 is a graph that illustrates the above-mentioned correspondence in the magnetic film whose Curie temperature before the ion injection is 600 K.

FIG. 7 is a graph that illustrates the above-mentioned correspondence in the magnetic film whose Curie temperature before the ion injection is 650K.

FIG. 8 is a graph that illustrates the above-mentioned correspondence in the magnetic film whose Curie temperature before the ion injection is 800 K.

FIG. 9 is a graph that illustrates the temperature dependence of the saturation magnetization before the ion injection, in the magnetic film having the Co/Pd artificial lattice structure and the film thickness of 5 nm, formed in the experiment.

FIG. 10 is a graph that illustrates the temperature dependence of the saturation magnetization in the magnetic film after the ion injection into the magnetic film having the temperature dependence in FIG. 9.

FIG. 11 is a graph that illustrates the correlation between the Curie temperature before the ion injection and the Curie temperature after the ion injection.

FIG. 12 is a graph that illustrates the amount-of-injected-ions dependence of the grating constant.

FIG. 13 is a graph that illustrates the grating-constant dependence of the saturation magnetization.

### DESCRIPTION OF EMBODIMENTS

Exemplary embodiments of the method of producing the magnetic storage medium, the magnetic storage medium and the information storage device for which the basic modes have been described above will be described below with reference to the drawings.

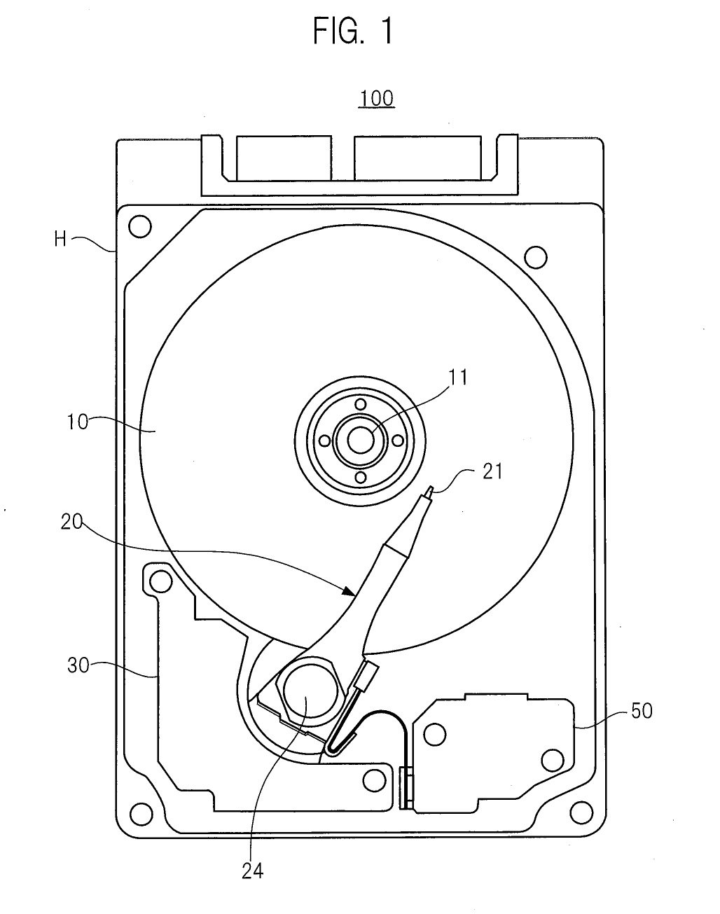

FIG. 1 is a diagram that illustrates an internal structure of a Hard Disk Device (HDD) that is an exemplary embodiment of the information storage device.

A Hard Disk Device (HDD) 100 illustrated in this FIG. 1 is incorporated into a host device such as a personal computer, and used as information storage means in the host device.

In this hard disk device 100, two or more circular-plate-like magnetic disks 10 are stacked in a depth direction of the diagram, and housed in a housing H. This magnetic disk 10 is equivalent to an exemplary embodiment of the magnetic storage medium for which the basic mode has been described above.

Here, with respect to the basic mode described above, the following applied mode is preferable. In this applied mode, the magnetic section is each of magnetic dots which are regularly arranged in plural arrays on the substrate, and on each of which information is magnetically recorded. Further, in this applied mode, the low magnetic section is a between-dot separating band provided between the magnetic dots and obstructing mutual magnetic coupling of the magnetic dots.

This applied mode is equivalent to a magnetic storage medium of the bit-patterned type in which magnetic dots where bit information is recorded are provided beforehand at the respective locations on a substrate. The magnetic storage medium of the bit-patterned type effectively avoids the interference and the thermal fluctuation phenomenon as described above and thus, the above-described applied mode equivalent to such a magnetic storage medium of the bit-patterned type is preferable.

The magnetic disk 10 of FIG. 1 is a magnetic storage medium of the bit-patterned type, and is also equivalent to an exemplary embodiment of this applied mode.

Further, this magnetic disk 10 is also a so-called perpendicular magnetic storage medium in which on each magnetic dot, information is recorded in the form of magnetic pattern by magnetization in a direction perpendicular to the front and back faces.

This magnetic disk 10 rotates about a disk spindle 11 in the housing H.

Further, in the housing H of the hard disk device 100, a swing arm 20, an actuator 30 and a control circuit 50 are also housed.

The swing arm 20 moves along the front and back faces of the magnetic disk 10. Further, this swing arm 20 holds, at the tip, a magnetic head 21 that performs writing and reading of information to and from the magnetic disk 10. Furthermore, the swing arm 20 is pivotably supported in the housing H by a bearing 24. And, this swing arm 20 is pivoted within a predetermined angle range about the bearing 24, to move the magnetic head 21 along the front and back faces of the magnetic disk 10. This magnetic head is equivalent to an example of the magnetic head in the above-described basic mode.

The actuator 30 is an element that drives the swing arm 20.

The control circuit 50 is an element that controls the driving of the swing arm 20 by the actuator 30, the reading and writing of information by the magnetic head 21, the exchange of information between this HDD 100 and the host device, and the like.

The combination of the swing arm 20, the bearing 24, the actuator 30 and the control circuit 50 is equivalent to an example of the head-position control system in the above-described basic mode.

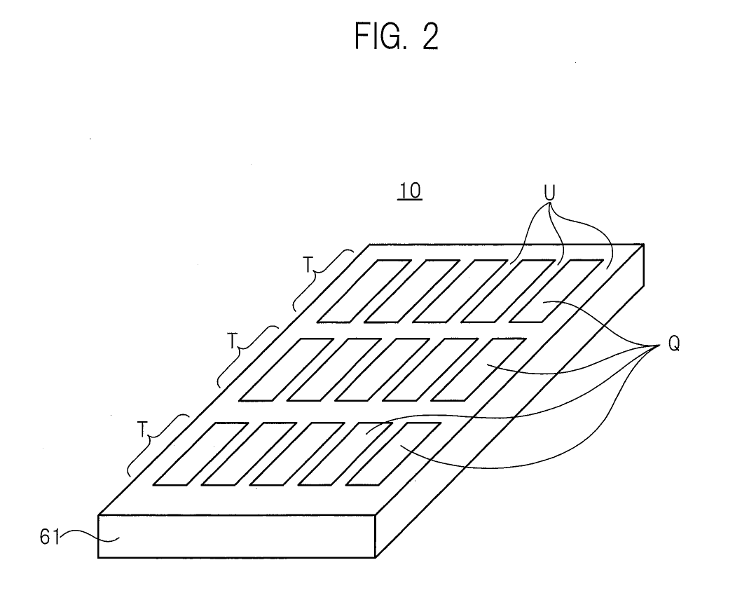

FIG. 2 is a perspective view that schematically illustrates the structure of the magnetic disk illustrated in FIG. 1.

In this FIG. 2, a part cut from the circular-plate-like magnetic disk 10 is illustrated.

The magnetic disk 10 illustrated in FIG. 2 has such a structure that plural magnetic dots Q are arranged in regular arrays on a glass substrate 61. Information corresponding to 1 bit is magnetically recorded in each of the magnetic dots Q. The magnetic dots Q are arranged to be shaped like a circular orbit around the center of the magnetic disk 10, and a column of the magnetic dots forms a track T. The glass substrate 61 is equivalent to an example of the substrate in the above-described basic modes. Further, the magnetic dots Q are equivalent to an example of the magnetic section in the above-described basic modes, and are also equivalent to an example of the magnetic dot in the applied mode corresponding to the magnetic storage medium of the bit-patterned type.

Furthermore, a part between the magnetic dots Q is a between-dot separating band U in which the magnetic anisotropy and the saturation magnetization are lower than the magnetic anisotropy and the saturation magnetization of the magnetic dots Q, and which magnetically divides the magnetic dots Q. The magnetic interaction between the magnetic dots Q is small due to this between-dot separating band U. This between-dot separating band U is equivalent to an example of the low magnetic section in the above-described basic modes, and is also equivalent to an example of the between-dot separating band in the applied mode corresponding to the magnetic storage medium of the bit-patterned type.

When the magnetic interaction between the magnetic dots Q is thus small, even at the time of recording and reproducing information to and from the magnetic dot Q, the magnetic interaction between the tracks T is small and thus, the so-called interference between the tracks is small. Further, in each of the magnetic dots Q, the border of a recorded information bit does not fluctuate by heat, and the so-called thermal fluctuation phenomenon is avoided. Thus, according to the magnetic disk 10 of the bit-patterned type as illustrated in this FIG. 2, reduction of the track width and shortening of the recording bit length are possible, and it is possible to obtain the magnetic storage medium with a high recording density.

A method of producing this magnetic disk 10 will be described below.

Here, a method of producing a magnetic disk in the present embodiment is the method of producing the magnetic disk 10 illustrated in FIG. 1 and FIG. 2 by using an ion doping system.

In the following, before the description of the method of producing the magnetic disk in the present embodiment, a comparative example to be compared with the ion doping system used in this production method will be described. This comparative example is a production method of a type producing a magnetic storage medium of the bit-patterned type, by etching and filling with a nonmagnetic material.

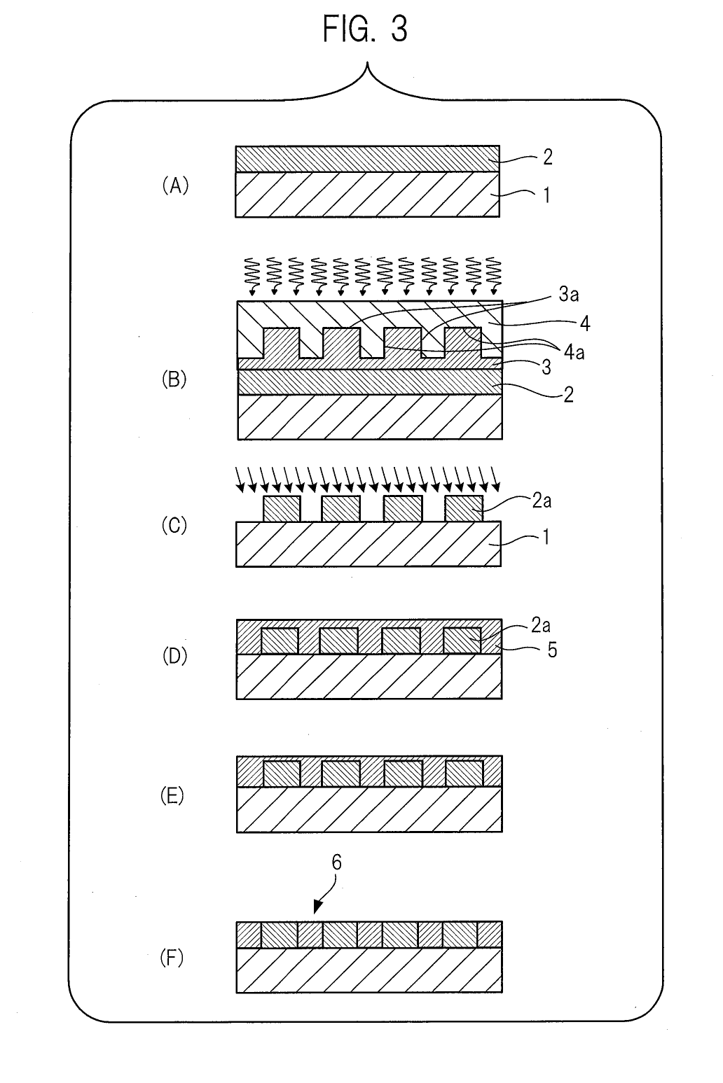

FIG. 3 is a diagram that illustrates the production method of the type producing the magnetic storage medium of the bit-patterned type, by etching and filling with the nonmagnetic material.

In this type of production method, first, a magnetic film 2 is formed on a substrate 1 in a film-forming process (A).

Next, in a nano-imprint process (B), a resist 3 made of a UV curable resin is applied onto the magnetic film 2, a mold 4 having nano-sized holes 4a is mounted on the resist 3. As a result of this, the resist 3 enters the nano-sized holes 4a, thereby forming dots 3a of the resist 3. And then, the resist 3 is irradiated with ultraviolet light over the mold 4 so that the resist 3 is cured and the dots 3a are printed on the magnetic film 2. Further, after the resist 3 is cured, the mold 4 is removed.

Subsequently, the etching is performed in an etching process (C), so that the magnetic film is removed, while leaving magnetic dots 2a protected by the dots 3a of the resist 3. After the etching, the dots 3a of the resist 3 are removed by a chemical process, so that only the magnetic dots 2a remain on the substrate 1.

Subsequently, in a filling process (D), a part between the magnetic dots 2a is filled with a non-magnetic material. Afterwards, the surface is flattened in a flattening process (E), so that a magnetic storage medium 6 of the bit-patterned type is completed (F).

According to this type of production method, in order to stabilize the floating property of a magnetic head above the magnetic storage medium 6, the flattening with high accuracy is necessary in the flattening process (E). Therefore, there arise such a problem that a very complicated manufacturing process needs to be performed and such a problem that the production cost increases.

On the other hand, in the present embodiment, the ion doping system is employed as mentioned above.

The method of producing the magnetic disk 10 by using this ion doping system in the present embodiment is equivalent to an exemplary embodiment of the method of producing the magnetic storage medium for which the basic mode has been described above.

Here, for the above-described basic mode, the following applied mode is preferable. That is to say, the ion-injection includes locally injecting, by using plural points arranged regularly in a direction in which the magnetic film spreads as the protected area, the ions between the plural points.

This applied mode is equivalent to a method of producing a magnetic storage medium of the bit-patterned type. The magnetic storage medium of the bit-patterned type effectively avoids the interference and the thermal fluctuation phenomenon as described above and thus, the above-described applied mode of producing such a type of magnetic storage medium is preferable. The method of producing the magnetic disk 10 to be described below is also equivalent to an exemplary example of this applied mode.

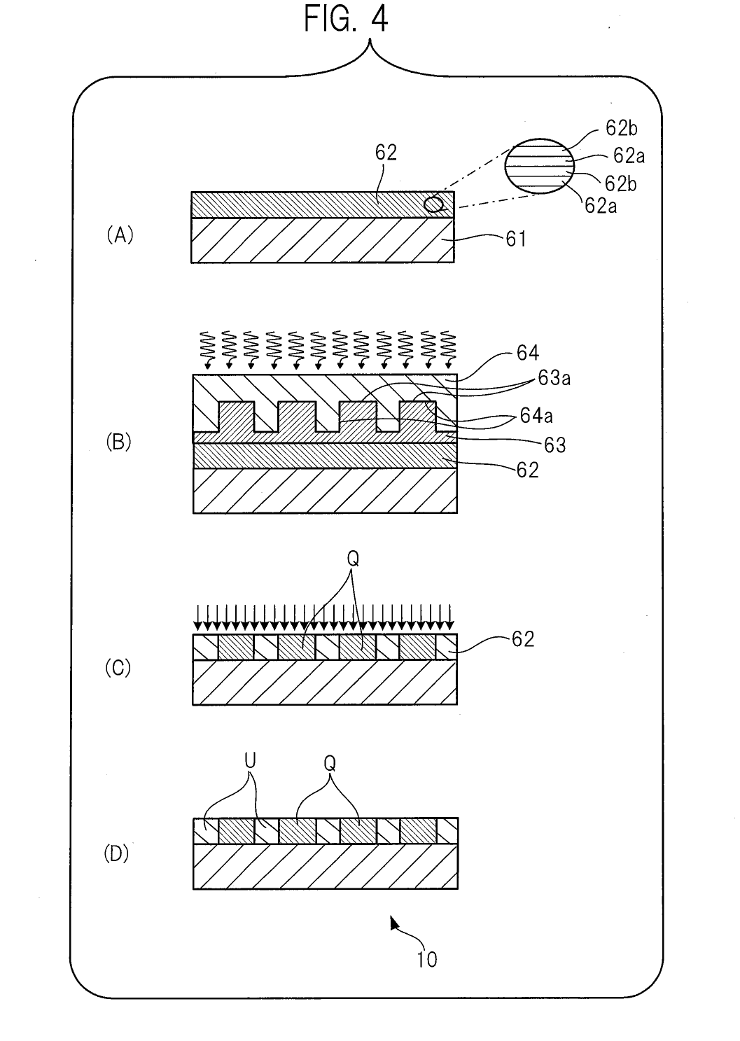

FIG. 4 is a diagram that illustrates the method of producing the magnetic disk illustrated in FIG. 1 and FIG. 2, by using the ion doping system.

In the production method illustrated in this FIG. 4, at first, in a film-forming process (A), a not-illustrated base layer to make a magnetic layer 62 have crystal orientation is formed on the glass substrate 61, and the magnetic layer 62 to be describe later is formed on the base layer. Further, on the magnetic layer 62, a not-illustrated protective layer made of diamond-like carbon is formed.

In the present embodiment, the magnetic film 62 formed in this film-forming process (A) is a magnetic film having an artificial lattice structure in which Co atomic layers 62a and Pd atomic layers 62b are laminated alternately. Further, in the present embodiment, this magnetic film 62 is formed to make the Curie temperature of the magnetic film 62 become 600 K or lower.

The reason why the formation of the magnetic film 62, in which the Curie temperature is thus focused on, is performed in the film-forming process (A) is as follow.

In the present embodiment, as will be described later, the between-dot separating band U in FIG. 2 is formed by performing the ion injection into the magnetic film 62 formed in the film-forming process (A). Here, in order that the magnetic dots Q may be effectively separated by this between-dot separating band U, it is desirable that the saturation magnetization of the between-dot separating band U be not more than 20% of the saturation magnetization of the magnetic dot Q. In other words, to obtain the above-mentioned effective separation, it is desirable, for the magnetic film 62, that the saturation magnetization after the ion injection be not more than 20% of the saturation magnetization before the ion injection. The percentage of the saturation magnetization after the ion injection of the saturation magnetization before the ion injection will be hereafter referred to as a saturation magnetization vanishing degree due to the ion injection.

Here, the developer of the present case has found that, mathematically, there is the following relation between the Curie temperatures of the magnetic film before and after the ion injection and the saturation magnetization vanishing degree due to the ion injection.

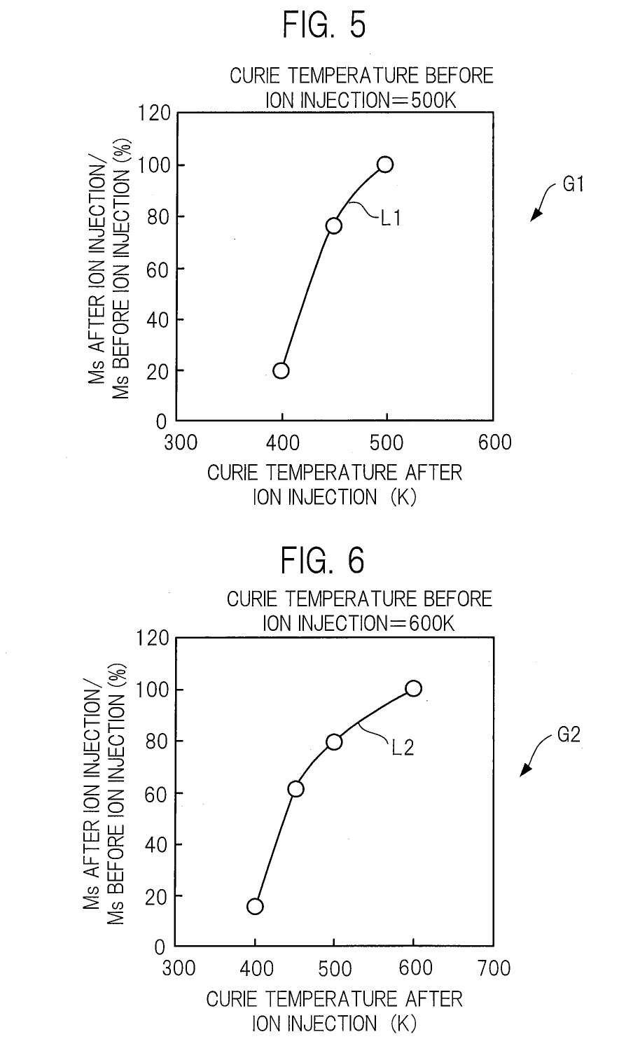

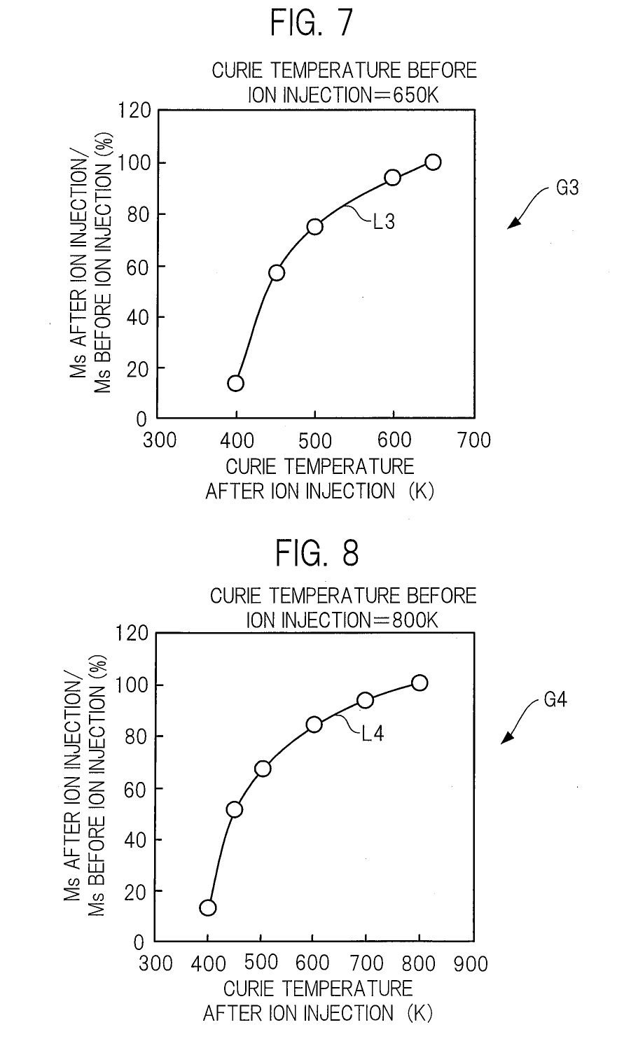

FIG. 5 is a graph that illustrates a calculative correspondence between the saturation magnetization vanishing degree due to the ion injection and the Curie temperature after the ion injection, in the magnetic film with the Curie temperature of 500 K before the ion injection. Further, FIG. 6 is a graph that illustrates the above-mentioned correspondence in the magnetic film whose Curie temperature before the ion injection is 600 K. Furthermore, FIG. 7 is a graph that illustrates the above-mentioned correspondence in the magnetic film whose Curie temperature before the ion injection is 650K. Moreover, FIG. 8 is a graph that illustrates the above-mentioned correspondence in the magnetic film whose Curie temperature before the ion injection is 800 K.

In each of graphs G1 to G4, the saturation magnetization vanishing degree due to the ion injection is on a vertical line, and the Curie temperature after the ion injection is on a horizontal axis. Further, in the graphs G1 to G4, the respective lines L1 to L4 linking white circles each represent the calculative correspondence between the saturation magnetization vanishing degree due to the ion injection and the Curie temperature after the ion injection.

Incidentally, in each of the graphs G1 to G4, determined by calculation as the saturation magnetization vanishing degree due to the ion injection is a saturation magnetization vanishing degree due to the ion injection at room temperature (300K), corresponding to temperature environments at the time of producing the magnetic disk and at the time of using the produced magnetic disk.

Further, the calculation here is performed under such a condition that the saturation magnetization at room temperature (300 K) before the ion injection is 500 emu/cm³. This condition is based on the fact that for a magnetic film having an artificial lattice structure similar to the magnetic film 62 formed in the above-described film-forming process (A) in FIG. 4 and having a film thickness of 5 nm, the saturation magnetization at room temperature (300 K) was measured and determined as 500 emu/cm³.

It is apparent from each of these graphs G1 to G4 that the Curie temperature after the ion injection when the saturation magnetization vanishing degree due to the ion injection becomes the above-mentioned desirable value (equal to or less than 20%) is in a range of 400 K to 420 K or below, without depending on the Curie temperature before the ion injection. On the other hand, the Curie temperature of the magnetic film falls by the ion injection. And, the larger the amount of injected ions is, the greater the amount of the fall is. Therefore, the amount of injected ions required to lower the Curie temperature of the magnetic film to the temperature equal to or lower than the above-mentioned desirable temperature becomes larger as the Curie temperature before the ion injection increases. However, when this amount of injected ions becomes too large, there arises a problem such as deterioration of the surface state of the magnetic film subjected to the ion injection, or the like. Generally, the practical amount of injected ions by which the deterioration of the surface state of the magnetic film is restrained is desired to be equal to or less than 1×10¹⁷ atoms/cm².

Here, in order to lower the Curie temperature of the magnetic film to the above-mentioned desirable temperature or lower with such a practical amount of injected ions, the Curie temperature before the ion injection may only need to be 600 K or lower, which has been found by the developer of this case through the following experiment.

In this experiment, like the film-forming process (A) in FIG. 4, a base layer, a magnetic film having an artificial lattice structure, and a protective layer are formed on a glass substrate in the following procedure.

Incidentally, various film-forming conditions described below are similar to the film-forming conditions in the film-forming process (A) in FIG. 4.

First, a glass substrate washed well was set in a magnetron sputtering device, and evacuation was performed up to 5×10⁻⁵ Pa or less. Subsequently, at an Ar gas pressure of 0.67 Pa, without heating the glass substrate, a 5-nm-thick film of (111) crystal-oriented fcc-Pd was formed as a base layer for making the magnetic layer have crystal orientation.

Subsequently, successively without returning to the air pressure, a magnetic film having a Co/Pd artificial lattice structure was formed at the Ar gas pressure of 0.67 Pa by repeating a film thickness structure of 0.3/0.35 nm eight times to be laminated. This film thickness structure means an artificial lattice in which a Co atomic layer and a Pd atomic layer are repeated, and the film thickness in total of the magnetic film is about 5 nm.

After the magnetic film was formed, a 4-nm-thick film of diamond-like carbon was formed as a protective layer.

After a laminate where the glass substrate, the base layer, the magnetic film, the protective layer were laminated was formed in this way, the Curie temperature of the magnetic film at this stage, namely, before the ion injection, was measured as follows.

This measurement of the Curie temperature is performed in such a manner that while the above-mentioned laminate is heated in stages, the saturation magnetization of the magnetic film at the temperature in each stage is measured, and thereby the temperature dependence of the saturation magnetization of the magnetic film is obtained. In the measurement of the saturation magnetization, SQUID (Superconducting Quantum Interference Device) is used. And, in the temperature dependence of this saturation magnetization, the temperature at which the saturation magnetization is zero becomes the Curie temperature of the magnetic film.

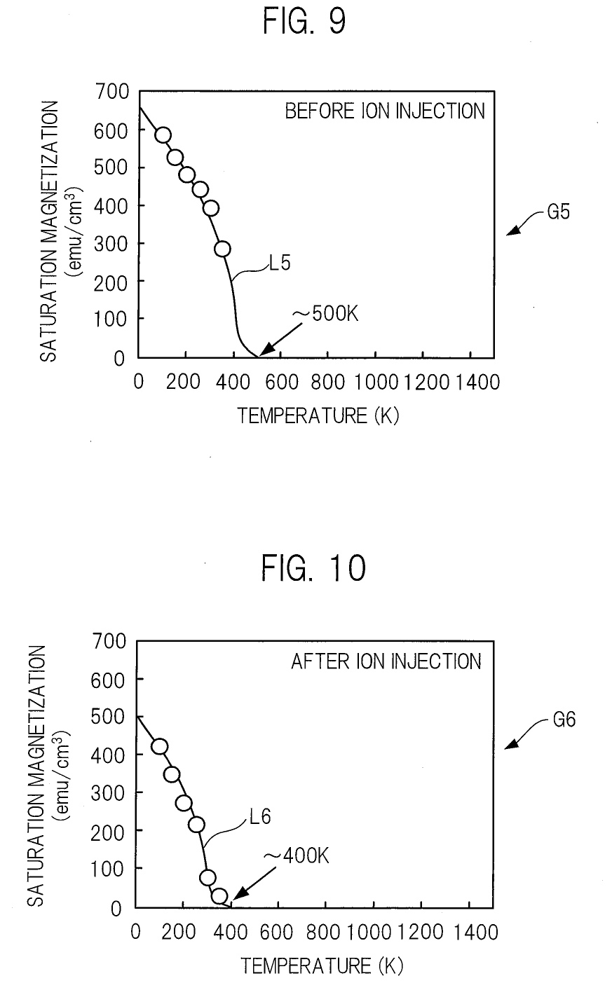

FIG. 9 is a graph that illustrates the temperature dependence of the saturation magnetization before the ion injection, in the magnetic film having the Co/Pd artificial lattice structure and the film thickness of 5 nm, formed in the experiment.

In a graph G5 in this FIG. 9, the saturation magnetization is on a vertical axis, and the temperature is on a horizontal axis. Further, in this graph G5, the temperature dependence of the saturation magnetization in the magnetic film before the ion injection is represented by a line L5 linking white circles. In the example of this graph G5, it is clear that the Curie temperature that is the temperature at which the saturation magnetization becomes zero is 500 K, in the magnetic film before the ion injection.

After the Curie temperature of the magnetic film before the ion injection was obtained in this way, the magnetic film was subjected to the ion injection by emitting mixed ions of N₂⁺ ion and N⁺ ion to the laminate. The ionic acceleration voltage in this ion injection was set to 6 keV at which the ions are injected into to a central part of the magnetic film. Further, the amount of injected ions was set in a range of 1×10¹⁶ to 4×10¹⁶ atoms/cm² which is equal to or less than the practical amount of injected ions that is 1×10¹⁷ atoms/cm².

Various injection conditions such as the type of ions, the acceleration voltage, and the amount of injected ions in the ion injection of the experiment here are similar to the injection conditions in an ion injection process (C) in FIG. 4 to be described later.

Further, after this ion injection, the Curie temperature of the magnetic film after the ion injection was obtained by measuring the temperature dependence of the saturation magnetization in the magnetic film after the ion injection, in the same procedure as the above-described procedure.

FIG. 10 is a graph that illustrates the temperature dependence of the saturation magnetization in the magnetic film after the ion injection into the magnetic film having the temperature dependence in FIG. 9.

In a graph G6 of this FIG. 10, the saturation magnetization is on a vertical axis, and the temperature is on a horizontal axis. Further, in this graph G6, the temperature dependence of the saturation magnetization in the magnetic film after the ion injection is represented by a line L6 linking white circles. In the example of this graph G6, it is found that the Curie temperature that is the temperature at which the saturation magnetization becomes zero is 400K, in the magnetic film after the ion injection.

In this experiment, as described above, for the magnetic film having the Co/Pd artificial lattice structure and the film thickness of 5 nm, the Curie temperatures before and after the ion injection were obtained.

Further, in this experiment, for a magnetic film having the Co/Pd artificial lattice structure and a film thickness of 10 nm, a magnetic film made of Co—Cr—Pt alloy and having a film thickness of 5 nm, and a magnetic film made of Co—Cr—Pt alloy and having a film thickness of 10 nm, the Curie temperatures before and after the ion injection were obtained in a similar procedure.

And, a group of four kinds of Curie temperatures before and after the ion injection obtained in this way was plotted on a graph as follows, and a correlation between the Curie temperature before the ion injection and the Curie temperature after the ion injection was obtained.

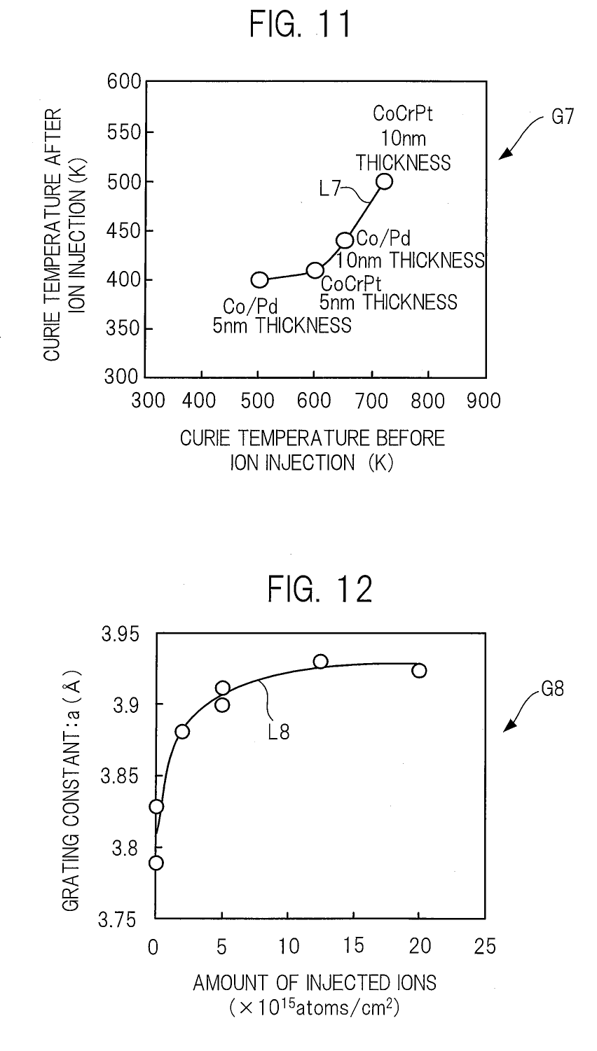

FIG. 11 is a graph that illustrates the correlation between the Curie temperature before the ion injection and the Curie temperature after the ion injection.

In a graph G7 illustrated in this FIG. 11, the Curie temperature after the ion injection is on a vertical axis, and the Curie temperature before the ion injection is on a horizontal axis. Further, in this graph G7, the correlation between the Curie temperature before the ion injection and the Curie temperature after the ion injection is represented by a line L7 linking white circles.

From the graph G7 of this FIG. 11, firstly, it is apparent that the higher the Curie temperature before the ion injection is, the higher the Curie temperature after the ion injection is. Further, it is apparent from the shape of the line L7 in this graph G7 that when the Curie temperature before the ion injection exceeds 600 K, the Curie temperature after the ion injection suddenly increases.

As described earlier, the Curie temperature after the ion injection when the saturation magnetization vanishing degree due to the ion injection becomes the desired value (equal to or less than 20%) is in the range of 400 K to 420 K or lower. And, it can be read from the graph G7 in this FIG. 11 that the Curie temperature before the ion injection to satisfy such a condition is equal to or lower than 600 K before the Curie temperature after the ion injection starts the sudden increase.

Based on the experiment described above, in the film-forming process (A) of FIG. 4, in order to obtain a desirable saturation magnetization vanishing degree in the ion injection process (C) to be described later, the magnetic film 62 is formed so that the Curie temperature becomes 600 K or lower. This film-forming process (A) is equivalent to an example of the magnetic-film-forming in the above-described basic mode.

Incidentally, when the Curie temperature of the magnetic film 62 is too low and becomes closer to the room temperature (300 K), then, the magnetic property itself of the magnetic film 62 weakens and becomes unsuitable for the production of the magnetic disk. In order to allow the magnetic film 62 to have a sufficient magnetic property at room temperature (300 K), the Curie temperature is desired to be about 500 K or higher.

In the film-forming process (A) of the present embodiment, the magnetic film 62 is formed so that the Curie temperature becomes 600 K or lower and also the Curie temperature becomes 500 K or higher.

Here, it is apparent from the graph G7 illustrated in FIG. 4 that when the materials forming the magnetic films are the same, the thinner the film thickness of the magnetic film is, the lower the Curie temperature becomes.

Thus, in the film-forming process (A) of FIG. 4, the magnetic film 62 is formed to have a film thickness corresponding to the Curie temperature satisfying the above-described temperature range.

This means that for the above-described basic mode, such an applied mode that the magnetic-film-forming includes forming the magnetic film with a film thickness by which the Curie temperature of the magnetic film becomes 600 K or lower is preferable.

The film-forming process (A) is also equivalent to an example of this applied mode.

In this film-forming process (A), the magnetic film 62 is formed to have a film thickness that allows the Curie temperature to be 600 K or lower and 500 K or higher (for example, the film thickness of 5 nm in the above-described experiment).

Next, in the nano-imprint process (B), a resist 63 made of a UV curable resin is applied onto the magnetic film 62, and a mold 64 having nano-sized holes 64a is mounted on the resist 63, and thereby the resist 63 enters the nano-sized holes 64a and becomes dots 63a of the resist 63, and the resist 63 is irradiated with ultraviolet light over the mold 64 and thereby cured, so that the dots 63a are printed on the magnetic film 62. After the resist 63 is cured, the mold 64 is removed.

After the nano-imprint process (B), the flow advances to the ion injection process (C) where the ions are emitted from above the magnetic film 62 on which the dots 63a are printed. In the present embodiment, in this ion injection process (C), the mixed ions of N₂⁺ ion and N⁺ ion are emitted, in a manner similar to the ion injection in the above-described experiment. Here, when colliding against the surface of the magnetic film 62, the N₂⁺ ion is separated into two N⁺ ions. For this reason, in this ion injection process (C), N⁺ ions are injected into the magnetic film 62. And, the saturation magnetization at the injected point decreases.

Here, when large-sized ions such as N⁺ ion are injected into the magnetic film by the ion injection, the grating constant in a crystal forming this magnetic film becomes large. In other words, the grating constant of this crystal expands. It is conceivable that a decrease in the saturation magnetization may occur due to this expansion.

The developer of this case has verified, by the following experiment, that a desirable effect of reducing the saturation magnetization is surely obtained by the expansion of the grating constant by the practical amount of injected ions.

In this experiment, the magnetic film having the Co/Pd artificial lattice structure and the film thickness of 5 nm was used as the magnetic film to be subjected to the ion injection. This magnetic film is, as described above, the magnetic film in which the Curie temperature before the ion injection is 600 K or lower (500 K).

To this magnetic film, the above-described mixed ions are emitted by increasing the amount of injected ions from zero to 2×10¹⁶ atoms/cm³ in stages. Further, in each stage, the grating constant and the saturation magnetization of the magnetic film were measured. The measurement of the grating constant was performed by calculating the grating constant of the magnetic film, from the diffraction angle of (111) surface of Co of the magnetic film measured by an X-ray diffraction method. Furthermore, the saturation magnetization was measured by using the above-mentioned SQUID.

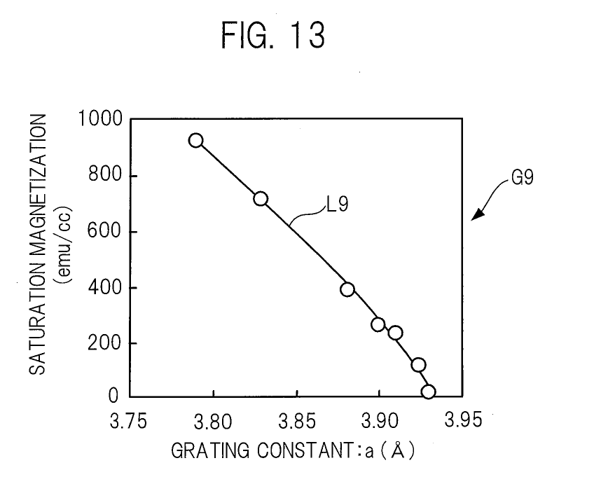

FIG. 12 is a graph that illustrates the amount-of-injected-ions dependence of the grating constant, and FIG. 13 is a graph that illustrates the grating-constant dependence of the saturation magnetization.

In a graph G8 of FIG. 12, the grating constant is on a vertical axis, and the amount of injected ions is on a horizontal axis. Further, in this graph G8, the amount-of-injected-ions dependence of the grating constant is represented by a line L8 linking white circles.

Furthermore, in a graph G9 of FIG. 13, the saturation magnetization is on a vertical axis, and the grating constant is on a horizontal axis. Moreover, in this graph G9, the grating-constant dependence of the saturation magnetization is represented by a line L9 linking white circles.

From these graphs G8 and G9, it is apparent that even with the ion injection in a range of 1×10¹⁶ to 2×10¹⁶ atoms/cm² which is less than the above-mentioned practical amount of injection, the grating constant sufficiently expands and the saturation magnetization may be decreased to 20% or lower of that before the ion injection. In other words, from this experiment, it may be verified that the desirable effect of reducing the saturation magnetization is reliably obtained by the expansion of the grating constant resulting from the practical amount of injected ions.

As apparent from the experiment described above, in the ion injection process (C) of FIG. 4, at the ion-injected point, with the above-described practical amount of injected ions, the saturation magnetization of the ion-injected point is sufficiently lowered, so that the favorable between-dot separating band U may be formed.

Here, for the above-described basic mode, such an applied mode that the ion-injection includes using either one of oxygen ions and nitrogen ions is preferable.

The developer of this case has discovered that by oxygen ion and nitrogen ion, the saturation magnetization of the magnetic film having the artificial lattice structure and the magnetic film made of Co—Cr—Pt based alloy described above may be effectively reduced. This applied mode is based on this discovery and thus is preferable.

The ion injection process (C) in FIG. 4 is also equivalent to an example of the ion-injection in this applied mode.

Further, for the above-described basic mode, the following applied mode is preferable as well. The method of producing the magnetic storage medium in this applied mode has mask-formation. The mask-formation includes forming a mask that obstructs injection of the ions into the protected area. And, in this applied mode, the ion-injection includes locally injecting, by applying the ions from above the magnetic film on which the mask is formed, the ions into an area other than the protected area protected by the mask.

According to this applied mode, an area where the ion injection is unnecessary is reliably protected by the mask and thus, formation accuracy of the magnetic dot is high. The nano-imprint process (B) in FIG. 4 is equivalent to an example of the-mask formation in this applied mode, and the ion injection process (C) is also equivalent to an example of the ion-injection in this applied mode.

Furthermore, for this applied mode having the mask-formation, an applied mode in which the mask-formation includes forming the mask with a resist is further preferable. Moreover, for the above-described applied mode having the mask-formation, an applied mode in which the mask-formation includes forming the mask with a resist, by a nano-imprint process also is further preferable.

Based on the mask formation by the resist, technically stable and accurate mask formation may be expected, and the mask formation by the nano imprint process may easily create a mask pattern in a nano level and thus is desirable. The nano-imprint process (B) illustrated in this FIG. 4 is also equivalent to an example of the mask-formation in these further preferable applied modes.

Incidentally, in the above-described nano-imprint, the resist is not completely removed even in the point into which the ions should be injected. However, the ions penetrate the resist at a location where the resist is thin and are injected into the magnetic film 62, whereas at a location where the resist is thick (namely, a location where the dots 63a are formed), the ions are stopped at the resist and do not reach the magnetic film. For this reason, it is possible to form a desired dot pattern.

Further, in the ion injection process (C) illustrated in FIG. 4, an ionic acceleration voltage is set so that the ions are injected into a central part of the magnetic film 62. This acceleration voltage varies depending on the type of ions, and varies depending on the depth to the central part of the magnetic film and the material.

After the ions are injected in this ion injection process (C), the dots 63a of the resist are removed by a chemical process.

Through such an ion injection process (C), the between-dot separating band U in which the saturation magnetization is equal to or less than 20% of the magnetic dot Q is formed, and the magnetic storage medium 10 of the bit-patterned type is completed (D).

In the magnetic storage medium 10 produced in the production method illustrated in this FIG. 4, smoothness between the magnetic dots Q and the between-dot separating bands U forming the surface is the smoothness in the magnetic film 62 formed in the film-forming process (A) which is maintained as it is. For this reason, the flattening process as in the conventional technique illustrated in FIG. 1 is unnecessary, and the production method illustrated in this FIG. 4 is a simple method.

Furthermore, in the production method illustrated in this FIG. 4, the magnetic dots Q are protected by the dots 63a of the resist printed on the magnetic film 62. Therefore, the entire surface of the magnetic storage medium 10 may be irradiated with the ions at a time, and the ion injection into the necessary points may be sufficiently obtained by the ion irradiation for several seconds and thus, the mass productivity is not impaired.

As described above, according to the method of producing the magnetic disk in the present embodiment, a sufficient effect of reducing the saturation magnetization due to the ion injection may be obtained, by forming the magnetic film so that the Curie temperature becomes 600 K or lower. As a result, according to the method of producing the magnetic disk in the present embodiment, the magnetic disk of the bit-patterned type and the like may be produced simply and practically.

Incidentally, in the above description, the example of the magnetic storage medium of the bit-patterned type has been taken as an example of the magnetic storage medium, but the magnetic storage medium is not limited to the bit-patterned type, and may be, for example, of the discrete track type.

In the above description, specific values have been mentioned as the film-forming conditions in the magnetron sputtering device, but these conditions are not limited to the numerical values mentioned above, and may be other numerical values.

Moreover, in the above description, use of the resist pattern as a preferable mask for forming the magnetic dots has been taken as an example. In contrast, in the ion injection in the above-described basic mode, a process in which a stencil mask is disposed so as not to touch the surface of the medium and the ions are injected may be employed. According to this process, the resist application and the resist removal may be omitted.

Still Furthermore, in the above description, use of the nano-imprint process has been stated as the best example of the patterning of the resist, but electron beam exposure may be used in the patterning.

1. A method of producing a magnetic storage medium, the method characterized by comprising:
magnetic-film-forming including forming a magnetic film on a substrate such that a Curie temperature is 600 K or lower; and
ion-injection including locally injecting an ion into an area other than a predetermined protected area, for the magnetic film.

2. The method of producing the magnetic storage medium according to claim 1, characterized in that the magnetic-film-forming includes forming the magnetic film with a film thickness in which the Curie temperature of the magnetic film is 600 K or lower.

3. The method of producing the magnetic storage medium according to claim 1, characterized in that the ion-injection includes locally injecting, by using a plurality of points arranged regularly in a direction in which the magnetic film spreads as the protected area, the ion between the plurality of points.

4. The method of producing the magnetic storage medium according to claim 1, characterized in that the ion-injection includes using either one of an oxygen ion and an nitrogen ion.

5. The method of producing the magnetic storage medium according to claim 1, characterized by further comprising:
mask-formation including forming a mask that obstructs injection of the ion into the protected area, wherein
the ion-injection includes locally injecting, by applying the ion from above the magnetic film in which the mask is formed, the ions into an area other than the protected area protected by the mask.

6. The method of producing the magnetic storage medium according to claim 5, characterized in that the mask-formation includes forming the mask with a resist.

7. The method of producing the magnetic storage medium according to claim 5, characterized in that the mask-formation includes forming the mask with a resist, by a nano-imprint process.

8. A magnetic storage medium comprising:
a substrate;
a magnetic section which has a magnetic film formed on the substrate such that a Curie temperature is 600 K or lower and in which information is magnetically recorded; and
a low magnetic section which has an injected film in which an ion is injected into a magnetic film continuing to the magnetic film of the magnetic section, and has saturation magnetization smaller than saturation magnetization of the magnetic section.

9. The magnetic storage medium according to claim 8, characterized in that the magnetic section is each of magnetic dots which are regularly arranged in a plurality of arrays on the substrate, and on each of which information is magnetically recorded, and
the low magnetic section is a between-dot separating band provided between the magnetic dots and obstructing mutual magnetic coupling of the magnetic dots.

10. An information storage device characterized by comprising:
a magnetic storage medium that includes a substrate, a magnetic section which has a magnetic film formed on the substrate such that a Curie temperature is 600 K or lower and in which information is magnetically recorded, and a low magnetic section which has an injected film in which an ion is injected into a magnetic film continuing to the magnetic film of the magnetic section, and which has saturation magnetization smaller than saturation magnetization of the magnetic section;
a magnetic head that approaches or contacts the magnetic storage medium, to perform at least one of magnetically recording information and magnetically reproducing information for the magnetic section; and
a head-position control system that moves the magnetic head relatively to a surface of the magnetic storage medium, to position the magnetic head over the magnetic section for at least one of magnetically recording information and magnetically reproducing information by the magnetic head.

11. The information storage device according to claim 10, characterized in that the magnetic section is each of magnetic dots which are regularly arranged in a plurality of arrays on the substrate, and on each of which information is magnetically recorded, and the low magnetic section is a between-dot separating band provided between the magnetic dots and obstructing mutual magnetic coupling of the magnetic dots.
